(19) United States
(12) Patent Application Publication
(10) Pub. No.: US 2023/0102627 A1
(43) Pub. Date: Mar. 30, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Jo SUDA, Kanagawa (JP)

(73) Assignee: FUJIFILM Business Innovation Corp., Tokyo (JP)

(21) Appl. No.: 17/701,694

(22) Filed: Mar. 23, 2022

(30) Foreign Application Priority Data
Sep. 24, 2021 (JP) 2021-155222

(51) Int. Cl. G06F 8/65; G06F 8/61; G06F 11/30

(52) U.S. Cl. CPC G06F 8/65; G06F 8/61; G06F 11/302

(57) ABSTRACT

An information processing apparatus includes a processor configured to: accumulate use-record information in a storage unit, the use-record information including utilization of multiple functions in a device in a predetermined period, the device having software including the functions; and, when the software needs to be updated, exert control to cause a function to be selected, for update, among the functions included in the software, the selected function having been used in the device, the selection being performed by referring to the use-record information.

### CROSS-REFERENCE TO RELATED APPLICATIONS

This application is based on and claims priority under 35 USC 119 from Japanese Patent Application No. 2021-155222 filed Sep. 24, 2021.

### BACKGROUND

### (i) Technical Field

The present disclosure relates to an information processing apparatus, a non-transitory computer readable medium, and an information processing method.

### (ii) Related Art

Recently, software installed in devices has become multifunctional, and has been provided with various additional service functions. However, even when the software is multifunctional, users of the devices may often use certain functions repeatedly among the functions provided by the software. There may be functions, which are not used at all by users, among the functions provided by the software.

Typically, for example, to fix bugs or improve functions, software is updated on an as-needed basis, which may depend on contracts or the like. An update of software is generally called, for example, an “upgrade”.

A technique of the related art is disclosed in Japanese Unexamined Patent Application Publication No. 2014-085759.

However, in the related art, software is updated uniformly on a software-by-software basis without consideration of users' use of the functions included in the software. In other words, functions, which are not used by users, are also updated. Thus, the time necessary for an update of the functions, which are not used by users, is wasteful.

### SUMMARY

Aspects of non-limiting embodiments of the present disclosure relate to a technique for improving the time efficiency of an update of the software installed in an information processing apparatus, compared with the case in which a use history of the functions included in the software is not referred to.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a processor configured to: accumulate use-record information in a storage unit, the use-record information including utilization of a plurality of functions in a device in a predetermined period, the device having software including the plurality of functions; and, when the software needs to be updated, exert control to cause a function to be selected, for update, among the plurality of functions included in the software, the selected function having been used in the device, the selection being performed by referring to the use-record information.

### BRIEF DESCRIPTION OF THE DRAWINGS

Exemplary embodiment of the present disclosure will be described in detail based on the following figures, wherein:

FIG. 1 is a block diagram illustrating the configuration of a computer system according to the present exemplary embodiment;

FIG. 2 is a diagram illustrating an exemplary data configuration of master data of models, which is stored in a master-data-of-models storage unit, according to the present exemplary embodiment;

FIG. 3 is a diagram illustrating an exemplary data configuration of contract information stored in a contract-information storage unit, according to the present exemplary embodiment;

FIG. 4 is a diagram illustrating an exemplary data configuration of manager information stored in a manager-information storage unit, according to the present exemplary embodiment;

FIG. 5 is a flowchart of a use-record management process according to the present exemplary embodiment;

FIG. 6 is a diagram illustrating an exemplary data configuration of a use history log accumulated in a use-history-log accumulation unit, according to the present exemplary embodiment;

FIG. 7 is a diagram illustrating an exemplary data configuration of function-used information stored in a function-used information storage unit, according to the present exemplary embodiment;

FIG. 8 is a flowchart of an upgrade setup process according to the present exemplary embodiment;

FIG. 9 is a diagram illustrating an exemplary data configuration of update information according to the present exemplary embodiment;

FIG. 10 is a diagram for describing how to determine whether an upgrade needs to be performed, according to the present exemplary embodiment;

FIG. 11 is a diagram illustrating an exemplary notification screen according to the present exemplary embodiment;

FIG. 12 is a diagram illustrating an exemplary firmware update setting list screen according to the present exemplary embodiment;

FIG. 13 is a diagram illustrating an exemplary firmware update setting detail screen according to the present exemplary embodiment;

FIG. 14 is a diagram illustrating an exemplary data configuration of reservation information stored in a reservation-information storage unit, according to the present exemplary embodiment; and

FIG. 15 is a flowchart of an upgrade execution control process according to the present exemplary embodiment.

### DETAILED DESCRIPTION

An exemplary embodiment of the present disclosure will be described below on the basis of the drawings.

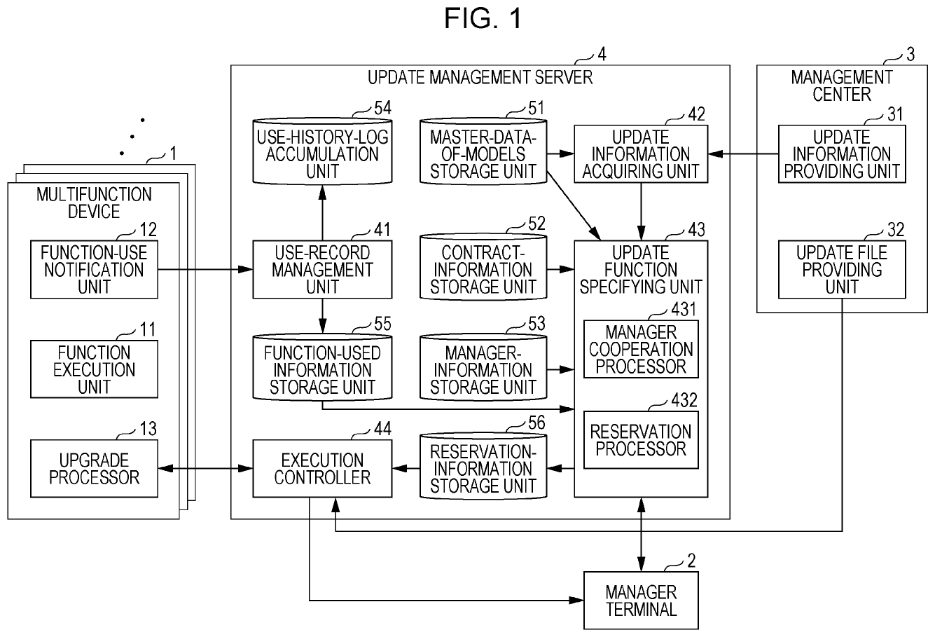

FIG. 1 is a block diagram illustrating the configuration of a computer system according to the present exemplary embodiment. FIG. 1 illustrates multifunction devices 1, a manager terminal 2, a management center 3, and an update management server 4. The update management server 4 is connected to the multifunction devices 1, the manager terminal 2, and the management center 3 over networks (not illustrated) in a bidirectional communicative manner. For example, the multifunction devices 1, the manager terminal 2, and the update management server 4 are disposed in facilities of the same business establishment or the like, and are connected to a local area network (LAN). The management center 3 is connected to the update management server 4 over the Internet.

The multifunction devices 1 are exemplary devices including software according to the present exemplary embodiment of the present disclosure. The multifunction devices 1 are used, for example, by employees in the business establishment. The multifunction devices 1, which are a form of image forming apparatus, include various functions, such as the print function, the copy function, and the scan function, and each include a computer therein. Thus, each multifunction device 1 includes a central processing unit (CPU), storage units, such as a read-only memory (ROM), a random-access memory (RAM), and a hard disk drive (HDD), a user interface such as an operation panel, and a network interface. Each multifunction device 1 includes a scanner and a printer to implement various functions such as printing. Further, each multifunction device 1 may be connected to additional devices for implementing additional functions, such as the finisher function, the puncher function, and the Internet fax function.

In the present exemplary embodiment, for convenience's sake, description will be made under the assumption that each multifunction device 1 includes a single piece of software installed therein. If each multifunction device 1 has multiple pieces of software installed therein, the processes described below may be performed on each piece of software. The software has one or more functions. A user selects, for execution, any of the functions of the software. Thus, in the present exemplary embodiment, the software is executed on a function-by-function basis. Accordingly, execution of the software actually indicates execution of only a single function selected by a user. As a matter of course, the case in which multiple functions operate in cooperation with each other may be assumed. However, in the present exemplary embodiment, it is assumed that only a function selected by a user is used.

In the present exemplary embodiment, “use” of a function has the same meaning as that of “execution” of a function. In addition, in the present exemplary embodiment, an upgrade is performed on a function-by-function basis. Upgrades of functions lead to an update of the software. In the present exemplary embodiment, the term, an “upgrade” of software or a function, and the term, an “update” of software or a function, are used as having the same meaning.

Each multifunction device 1 according to the present exemplary embodiment has a function execution unit 11, a function-use notification unit 12, and an upgrade processor 13. Components, which are not used in the description of the present exemplary embodiment, are not illustrated in FIG. 1. The function execution unit 11 performs functions specified by users. When the function execution unit 11 performs a function, the function-use notification unit 12 detects a user's use of the function. At that time, the function-use notification unit 12 notifies the update management server 4 of the use of the function on the multifunction device 1. Functions provided to users in the present exemplary embodiment are implemented by using applications which may be upgrade targets. The upgrade processor 13 upgrades the functions to update the software, and notifies the update management server 4 that an upgrade has been performed. The components 11 to 13 are implemented through cooperative operation between the computer of the multifunction device 1 and programs which are executed by the CPU included in the computer.

The manager terminal 2 is an information processing apparatus used by managers of the software executed on the multifunction devices 1. The manager terminal 2 may be implemented through an existing general-purpose hardware configuration such as a personal computer (PC). That is, the manager terminal 2 includes a CPU, storage units, such as a ROM, a RAM, and a hard disk drive, user interfaces, such as a mouse, a keyboard, and a display, and a network interface.

The multifunction devices 1, the manager terminal 2, and the update management server 4 are installed in facilities of the same business establishment, while the management center 3 is present outside of the business establishment and is a facility which provides, to business establishments, information about updates of the software. In particular, the management center 3 according to the present exemplary embodiment uses a server or the like to collectively manage information about updates of the software provided to the business establishments. In the present exemplary embodiment, the “management center 3” refers to not only a facility but also a “server installed in the management center 3”.

The management center 3 includes an update information providing unit 31 and an update file providing unit 32. In response to an inquiry from the update management server 4, the update information providing unit 31 transmits and provides update information, which corresponds to models indicated in the inquiry, if there is such update information. The “update information” is prepared for each model, and is generated when software for the model is updated. The “update information” includes description about the update. More strictly, the software is updated on a function-by-function basis. Thus, when at least one function of the model is updated, update information is generated. The generated update information includes update information about the updated functions, and does not include information about un-updated functions because the functions have not been updated.

The update file providing unit 32 provides update files in response to a transmission request from the update management server 4. An “update file” indicates a program executed to upgrade a function.

The update management server 4 is a server computer provided to manage upgrades of the software in one or more multifunction devices 1 installed in the business establishment. The update management server 4 according to the present exemplary embodiment may be implemented by using the hardware configuration of an existing general-purpose server computer. That is, the update management server 4 includes a CPU, storage units, such as a ROM, a RAM, and a hard disk drive, and a network interface. The update management server 4 may include a user interface when necessary.

As illustrated in FIG. 1, the update management server 4 according to the present exemplary embodiment includes a use-record management unit 41, an update information acquiring unit 42, an update function specifying unit 43, an execution controller 44, a master-data-of-models storage unit 51, a contract-information storage unit 52, a manager-information storage unit 53, a use-history-log accumulation unit 54, a function-used information storage unit 55, and a reservation-information storage unit 56. Components, which are not used in the description of the present exemplary embodiment, are not illustrated in FIG. 1.

The use-record management unit 41 generates a use history log about function-use records from function-use notification information transmitted from the multifunction devices 1, and accumulates the use history log in the use-history-log accumulation unit 54. In addition, the use-record management unit 41 summarizes the use history log in a predetermined period to generate function-used information, which includes utilization of functions in the predetermined period, and registers the function-used information in the function-used information storage unit 55.

The update information acquiring unit 42 specifies models and transmits, to the management center 3, an inquiry whether there is update information corresponding to the models. The update information acquiring unit 42 acquires update information, which is transmitted from the management center 3 in response to the inquiry.

With reference to the update information transmitted from the management center 3, the update function specifying unit 43 specifies, among the functions included in the software installed in each multifunction device 1, functions having been actually used in the multifunction device 1, as upgrade target functions. The update function specifying unit 43 includes a manager cooperation processor 431 and a reservation processor 432. The manager cooperation processor 431 communicates with each manager who uses the manager terminal 2 to make the manager specify upgrade target functions, which are to be actually upgraded, among the functions included in the software installed in the multifunction devices 1 managed by the manager. The reservation processor 432 performs a process of reserving upgrade processes. Thus, the reservation processor 432 generates reservation information, and registers the generated reservation information in the reservation-information storage unit 56.

The execution controller 44 obtains, from the management center 3, update files, which are necessary for upgrading, according to the reservation information registered in the reservation-information storage unit 56. The execution controller 44 transmits the obtained update files to the corresponding multifunction device 1 to instruct the multifunction device 1 to perform an upgrade. When the execution controller 44 receives notification of completion of the upgrade from the multifunction device 1, the execution controller 44 reports the completion to the manager terminal 2.

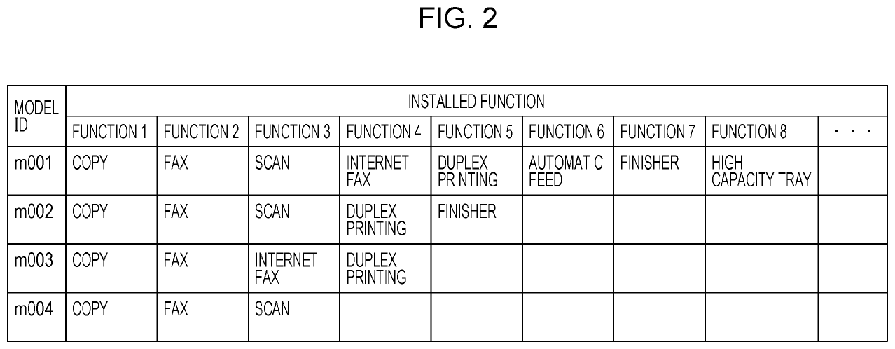

FIG. 2 is a diagram illustrating an exemplary data configuration of master data of models, which is stored in the master-data-of-models storage unit 51, according to the present exemplary embodiment. The master data of models is set by associating model identification information (hereinafter referred to as “model ID”), which serves as information for specifying the model of a multifunction device 1, with the installed functions of the model. As information for specifying a model, for example, the name of the model may be used. As the installed functions, a list of functions installed in the model is set. As illustrated in FIG. 2, the installed functions are different depending on the model.

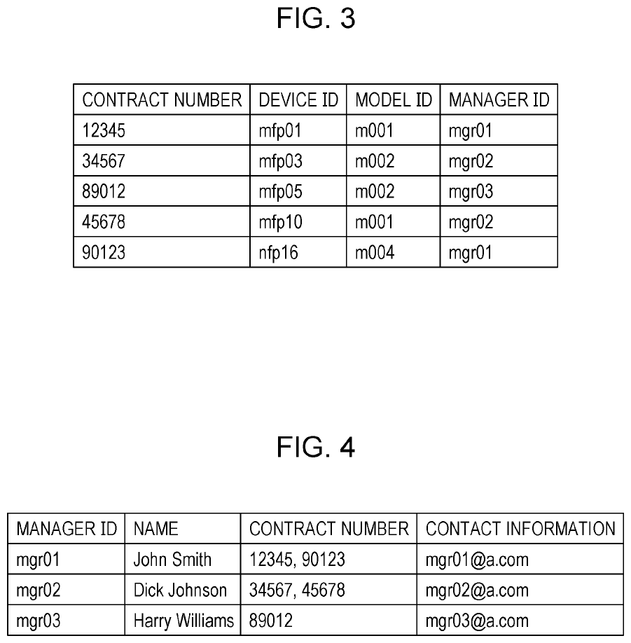

FIG. 3 is a diagram illustrating an exemplary data configuration of contract information stored in the contract-information storage unit 52, according to the present exemplary embodiment. In the present exemplary embodiment, the multifunction devices 1 are installed in a business establishment in response to conclusion of contracts. The contract information describes the contracts. The contract information is set by associating the contract number, which identifies a contract, with the device ID, the model ID, and the manager ID. As the device ID, device identification information, which is information for identifying a multifunction device 1 installed in the business establishment according to the contract, is set. As the device ID, for example, the serial number of the multifunction device 1 or the name of the multifunction device 1 may be used. As the model ID, as described above, information for specifying the model of the device is set. As the manager ID, identification information of a manager (hereinafter referred to as a “manager ID”), which is information for identifying the manager of the multifunction device 1 installed in the business establishment according to the contract, is set.

FIG. 4 is a diagram illustrating an exemplary data configuration of manager information stored in the manager-information storage unit 53, according to the present exemplary embodiment. The manager information includes information about the managers of the multifunction devices 1. The manager information according to the present exemplary embodiment is set by associating the manager ID, which serves as identification information for identifying a manager, with the manager name, the contract number, and the contact information. As the manager name, the name of the manager is set. As the contract number, the contract numbers of contracts, according to which the manager is assigned as the manager of multifunction devices 1, are set. As the contact information, information about the contact to the manager is set. According to the present exemplary embodiment, it is assumed that mail is used in notification to managers. Thus, as the contact information, the mail address of the manager is set.

The storage units 54 to 56, which are not described above, store information generated during processing, and will be described in description of the processing.

The components 41 to 44 in the update management server 4 are implemented through collaborative operation between the computer, of which the update management server 4 is formed, and programs which are executed by the CPU included in the computer. The storage units 51 to 56 are implemented by using an HDD included in the update management server 4. Alternatively, the RAM may be used, or a storage unit, which is present outside, may be used over a network.

The programs used in the present exemplary embodiment may be provided not only through a communication unit, but also through storage of the programs in a computer-readable recording medium, such as a compact disc-read-only memory (CD-ROM) or a Universal Serial Bus (USB) memory. The programs provided through the communication unit or a recording medium are installed in the computer. The CPU of the computer executes the programs sequentially to implement various processes.

When the software installed in a multifunction device 1 is to be upgraded, for example, the manager operates the multifunction device 1 to download update files from the management center 3 for upgrading. In the related art, software is collectively upgraded on a software-by-software basis. Even when some of the functions included in the software are not used by the users of the multifunction device 1, such functions are also upgraded. Upgrades of the functions, which are not used, are not necessary. Rather, the time necessary for upgrades of the functions, which are not used by users, is wasteful.

Accordingly, in the present exemplary embodiment, the update management server 4 is disposed between the multifunction devices 1 and the management center 3. In an upgrade of the software of a multifunction device 1, the update management server 4 refers to utilization of the functions of the multifunction device 1 to select functions, which are to be upgraded, from the functions included in the software. That is, the functions, which are not used by users, are not to be upgraded. Thus, efficiency in time is improved.

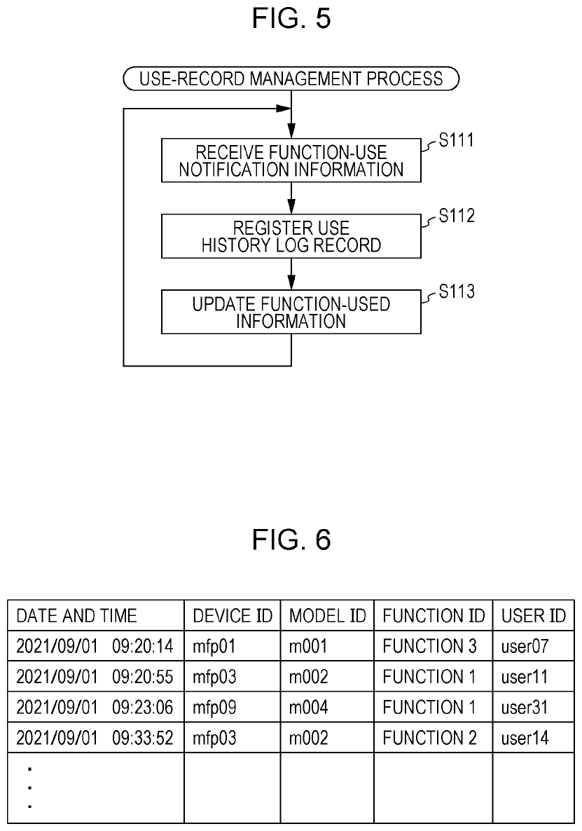

The operation according to the present exemplary embodiment will be described. A use-record management process, which is performed by the update management server 4 to grasp utilization of the functions of the multifunction devices 1, will be described by using the flowchart in FIG. 5.

In each multifunction device 1, the function execution unit 11 performs a function, which is selected by a user, in response to the user's operation. When the function-use notification unit 12 detects the user's use of the function, the function-use notification unit 12 transmits the function-use notification information to notify the update management server 4 of the use of the function.

When the use-record management unit 41 of the update management server 4 receives the function-use notification information transmitted from a multifunction device 1 (step 111), the use-record management unit 41 generates a use history log record which is registered in the use-history-log accumulation unit 54 (step 112). In addition, the use-record management unit 41 updates the function-used information to reflect the utilization of the function, which is specified by the received function-use notification information, in the function-used information (step 113).

FIG. 6 is a diagram illustrating an exemplary data configuration of a use history log accumulated in the use-history-log accumulation unit 54, according to the present exemplary embodiment. The use history log is information indicating records of function use in the multifunction devices 1, and has a configuration in which the date and time, the device ID, the model ID, the function ID, and the user ID are associated with each other. As the date and time, a date and time at which use of a function started is set. As the device ID, the device ID of a multifunction device 1 whose function was used is set. As the model ID, the model ID for specifying the model of the multifunction device 1 is set. As the function ID, the function ID for specifying the function used is set. As the user ID, identification information (hereinafter referred to as a “user ID”) of a user who used the function is set. In the use-history-log accumulation unit 54, at least the use history log corresponding to use of functions in a “predetermined period” described below may be accumulated.

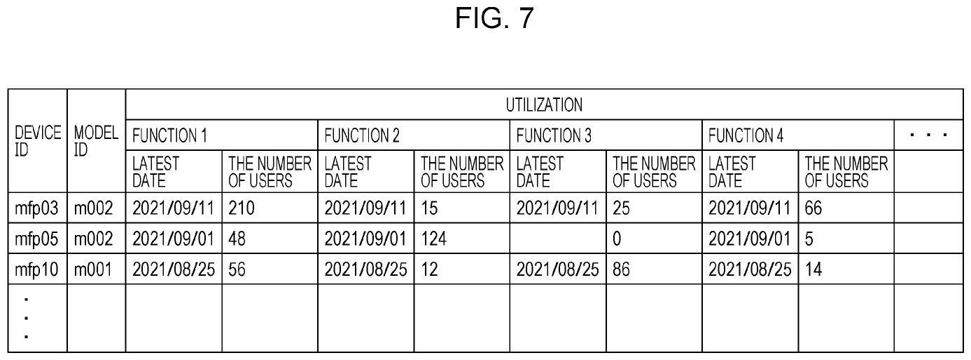

FIG. 7 is a diagram illustrating an exemplary data configuration of function-used information stored in the function-used information storage unit 55, according to the present exemplary embodiment. The function-used information is information indicating utilization of functions. The function-used information is also use-record information of functions since the function-used information is information which is set by referring to the use history log.

The function-used information is set by associating the device ID and the model ID with the utilization. As the device ID, the device ID of a multifunction device 1 whose functions were used is set. As the model ID, the model ID for specifying the model of the multifunction device 1 is set. As the utilization, utilization of each function used in the multifunction device 1 is set. Specifically, for each function installed in the multifunction device 1, the latest date and the number of users are set as utilization. As the latest date, the latest date when the function was used is set. The number of users is an exemplary index indicating utilization of the function. The number of users indicates how many users used the function, and is obtained by summarizing, for every function of each multifunction device 1, the use history log generated from use of functions in the predetermined period. Thus, the number of users may be record information about function use. Examples of an index indicating the utilization include a use frequency and a use time. In the present exemplary embodiment, as an index indicating a use frequency, “the number of users” who used the function is used. As the number of users, a total of users who used the function in the predetermined period is set. Herein, “the number of users” may be “the use count”.

The functions which are set in the utilization may be set by referring, in advance, the functions installed in the multifunction devices with reference to the master data of models. Alternatively, when the function included in the function-use notification information received from a multifunction device 1 is not set in the function-used information, the function included in the received function-use notification information may be added to the function-used information for registration.

A period in which the number of users is counted, that is, the “predetermined period”, may be set appropriately. In the present exemplary embodiment, the counter for “the number of users” is initialized when an upgrade is performed. That is, as the number of users which is included in the utilization, a value indicating the number of users who used the function from the previous upgrade is set. In this example, the number of users from the previous upgrade is used. Alternatively, the number of users may be initialized at a fixed time, for example, at the end of every week or the end of every month, to show the number of users in one week or one month.

In the present exemplary embodiment, only one index, which is “the number of users” from the previous upgrade, is included. Alternatively, the predetermined period may be set so that, for example, “the numbers of users” in multiple periods, such as the number of users per week in consecutive weeks, may be included in the function-used information to grasp the transition in the number of users. Alternatively, multiple indexes for which summarization in different periods is made, such as the number of users from the previous upgrade and the number of users of the previous single week, may be included in the function-used information.

The function-used information is one of the pieces of information provided to managers. This will be described below in detail. A manager may select functions, which are to be upgraded, by using the provided function-used information as a determination index. Accordingly, various types of information indicating the utilization as described above may be included in the function-used information.

As described above, in the present exemplary embodiment, every time the function-use notification information is received from a multifunction device 1, the log record is written and the function-used information is updated repeatedly. Each multifunction device 1 may transmit the function-use notification information every time a function is used. Alternatively, each multifunction device 1 may collectively transmit, to the update management server 4, the function-use notification information about use of the functions of the day at a predetermined time regularly, for example, at the end of the day.

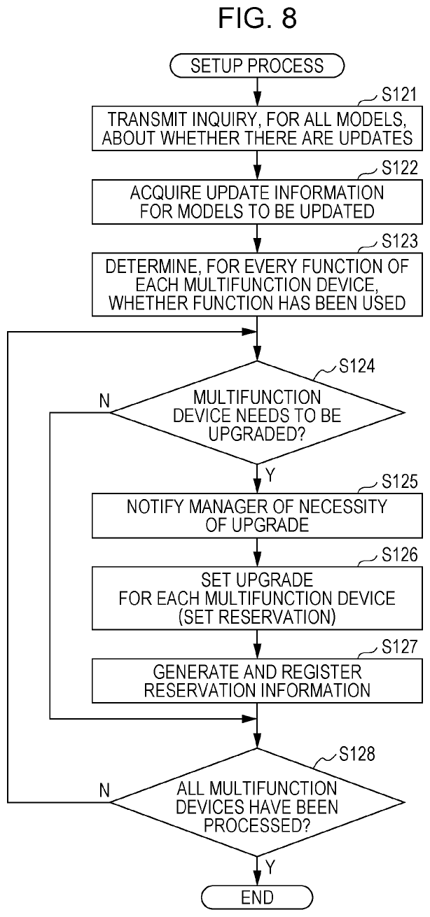

An upgrade setup process, which is performed by the update management server 4 after the function-use notification information is received from all the multifunction devices 1, will be described by using the flowchart in FIG. 8.

As described above, when reception of the function-use notification information for the day from all the multifunction devices 1 is confirmed, the update information acquiring unit 42 of the update management server 4 transmits, to the management center 3, an inquiry about whether there are updates for all the models registered in the master data of models (step 121). At that time, the update information acquiring unit 42 may additionally transmit information, indicating the date and time of the previous inquiry about updates of the models, to ask if there are updates after that date and time.

The update information providing unit 31 of the management center 3 checks if there is an update for each model in the inquiry. When there is an update, the update information providing unit 31 provides update information, corresponding to the model for which there is an update, to the update information acquiring unit 42.

The update information acquiring unit 42 of the update management server 4 acquires update information transmitted in response to the inquiry (step 122).

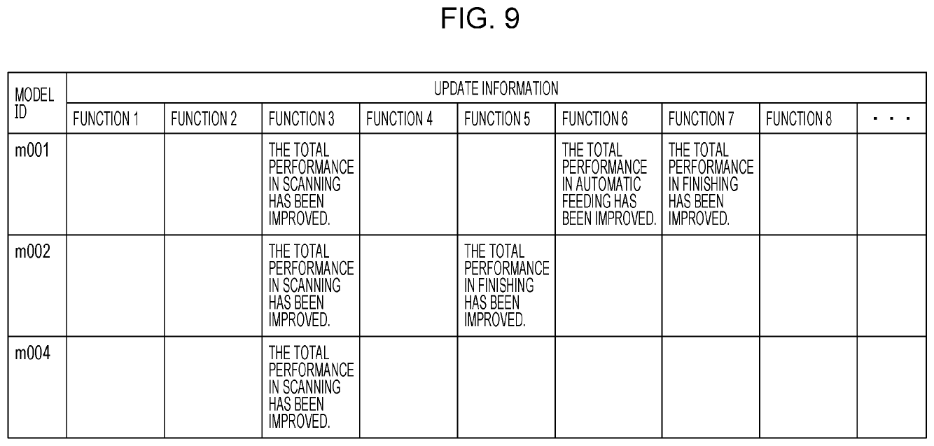

FIG. 9 is a diagram illustrating exemplary update information according to the present exemplary embodiment. In the present exemplary embodiment, an inquiry about the models, which are registered in the master data of models, is transmitted. Thus, the update information is illustrated in a table corresponding to the master data of models in FIG. 2. In FIG. 9, a blank field indicates no update information for the function. The update information in FIG. 9 indicates that there is update information for the finisher function, the scan function, and the automatic feed function. This indicates that these functions have been updated after the previous inquiry. For the model, whose model ID is “m003” and which includes none of the finisher function, the scan function, and the automatic feed function, update information has not been generated. Thus, no update information is transmitted from the management center 3. Through presentation of update information, the manager or the like may know what updates have been made for the updated functions.

Subsequently, the update function specifying unit 43 determines, for each multifunction device 1, which functions have been used in the predetermined period, that is, for each function, whether the function has been used (step 123). The update function specifying unit 43 refers to the function-used information to determine, for each function, whether the function has been used. This example will be described under the assumption that the value examples of the numbers of users in the function-used information in FIG. 7 indicate the numbers of users from the previous upgrade.

In determination, for each function, about whether the function has been used, a very simple way is to determine whether “the number of users” is zero. For example, in FIG. 7, the number of users of function 3 of the multifunction device 1 whose device ID is “mfp05” is “zero”, and the use of function 3 is determined to be “not used”. Hereinafter, the multifunction device 1 whose device ID is “mfp05” is described as the “multifunction device mfp05”, and the same is true for the other multifunction devices 1. The numbers of users of the other functions are one or more, and the use of the other functions may be determined to be “used”.

However, if the lapse time from the previous upgrade is long, and if the number of users of a function is not zero but very few, use of the function may be regarded as “not used”. In this case, a threshold of a predetermined number for determination about whether a function has been used may be set in advance. Each value in “the number of users” included in the function-used information may be compared with the threshold. If the number of users is equal to or greater than the threshold, it may be determined that the function has been used. If the number of users does not reach the threshold, it may be determined that the function is not used. The threshold may be set for each function, or may be set for each multifunction device 1.

Assume the case in which multiple indexes indicating utilization are set, for example, the case in which multiple indexes, for example, the number of users from the previous upgrade and the number of users in the previous week, are set. In this case, a condition, such as a determination expression in which these indexes are combined, may be set to determine, for each function, whether the function has been used.

As described above, the update function specifying unit 43 determines, for every function of each multifunction device 1, whether the function installed in the multifunction device 1 has been used. The update function specifying unit 43 determines, for each multifunction device 1, whether an upgrade is necessary, as described below.

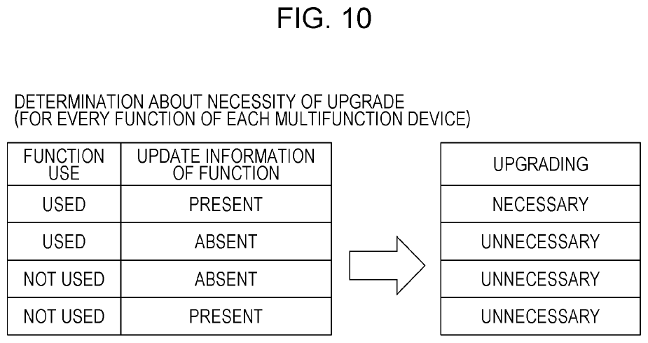

FIG. 10 is a diagram for describing how to determine whether an upgrade is necessary. In FIG. 10, a certain function of a certain multifunction device 1 is focused on. In the table in FIG. 10, “function use” indicates a determination result made by the update function specifying unit 43 as described above. “Update information of function” indicates whether update information has been acquired from the management center 3.

If a function has been used (that is, in FIG. 10, “function use” is “used”) and if update information corresponding to the function is present (that is, in FIG. 10, “update information of function” is “present”), the function has been used by users. Thus, as a matter of course, the function is to be upgraded. Accordingly, the function is an upgrade target (that is, in FIG. 10, “upgrade” is “necessary”).

If a function has been used, but if update information corresponding to the function is not present (that is, in FIG. 10, “update information of function” is “absent”), an update file for the function is not prepared. Thus, as a matter of course, upgrading the function is not possible. Accordingly, the function is not an upgrade target (that is, in FIG. 10, “upgrade” is “unnecessary”).

If a function is not used (that is, in FIG. 10, “function use” is “not used”), and if update information corresponding to the function is not present, as a matter of course, the function does not need to be upgraded. Accordingly, the function is not an upgrade target.

The following point is characteristic in determination about whether an upgrade is necessary, according to the present exemplary embodiment: even when update information corresponding to a function is present, if the function has not been used, upgrading the function is meaningless. Thus, the function is not an upgrade target.

For every function of each multifunction device 1, the update function specifying unit 43 generates tables, as illustrated in FIG. 10. Subsequently, the update function specifying unit 43 performs the following process for each multifunction device 1 on the basis of the determination, which is illustrated in FIG. 10, about whether an upgrade is necessary.

First, one multifunction device 1, which has not been processed, is focused on. If the software of the multifunction device 1 does not need to be upgraded (N in step 124), the process proceeds to the next multifunction device 1, which has not been processed. If the software of the multifunction device 1 needs to be upgraded (Y in step 124), in other words, if at least one function included in the software installed in the multifunction device 1 needs to be upgraded, a mail is transmitted to notify the manager of the multifunction device 1 of the necessity of an upgrade of the software (step 125). The manager of the multifunction device 1 and the destination of the mail may be specified by referring to the contract information and the manager information.

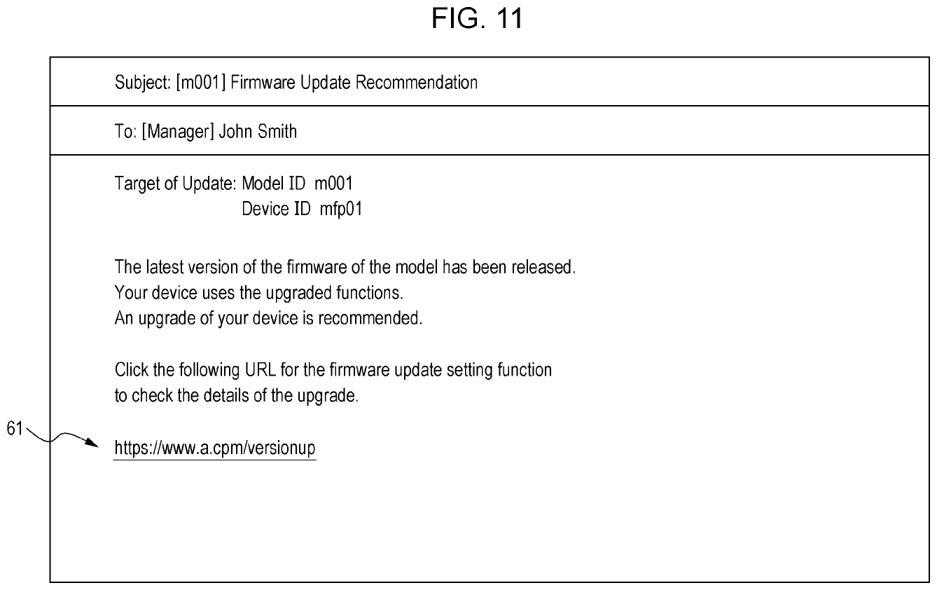

FIG. 11 is a diagram illustrating an exemplary notification screen displayed on the manager terminal 2 through transmission to the manager, according to the present exemplary embodiment. For example, the manager opens the notification message, which is transmitted by mail, to display, on a screen, the notification message illustrated in FIG. 11.

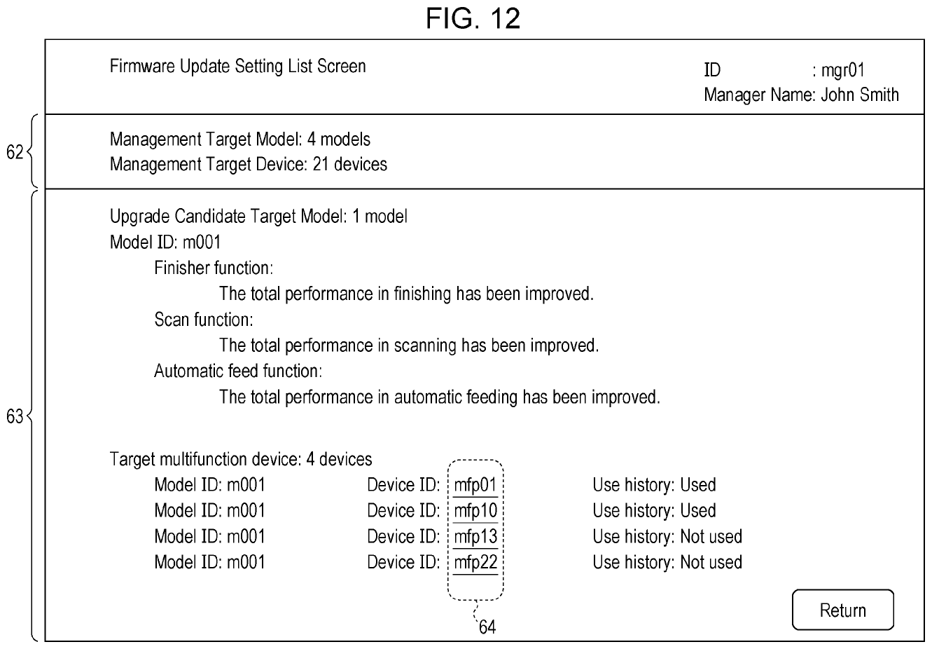

The manager refers to the notification and knows the necessity of an upgrade of the software (in the example in FIG. 11, firmware). When the manager is to make upgrade settings, the manager selects a hyperlink 61 on the screen. FIG. 12 illustrates an exemplary firmware update setting list screen displayed on the screen of the manager terminal 2 through this selection.

The manager cooperation processor 431 displays the firmware update setting list screen on the screen of the manager terminal 2 in response to selection of the hyperlink 61. For example, a browser installed in the manager terminal 2 may obtain, for display, a file for screen display.

In a management-target display area 62 on the firmware update setting list screen, the models and the multifunction devices 1, which are managed by the manager, are displayed as additional information. In an update information display area 63, the following information is displayed. That is, a model, which is to be updated, functions of the model, which are to be updated, and the multifunction devices 1, which correspond to the model, are displayed. The functions, which are to be updated, are displayed in association with description about updates of the functions obtained from the update information acquired from the management center 3. For each multifunction device 1 corresponding to the model, the result of determination, for each function in step 123, about whether the function has been used is displayed as “use history”. In this example, the case in which “use history” is “not used” corresponds to the case in which “function use” is “not used” in FIG. 10. Therefore, a multifunction device 1 for which “use history” is “not used” is not an upgrade target. In contrast, the case in which “use history” is “used” corresponds to the case in which “function use” is “used” in FIG. 10. Therefore, in the display example in FIG. 12, the multifunction device mfp01 and the multifunction device mfp10 are upgrade target candidates. Even if “use history” is “used”, and if there is a function for which no update information is present, the function is not an upgrade target.

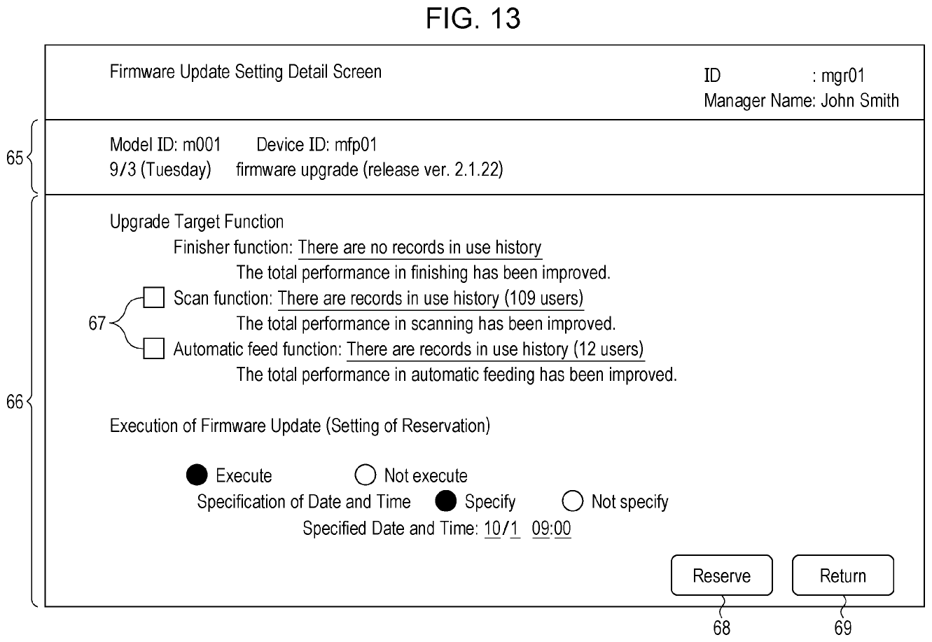

In the present exemplary embodiment, device IDs 64 of the multifunction devices 1 are underlined to indicate that the device IDs 64 are selectable by the manager. When the manager selects any of the device IDs 64, the manager cooperation processor 431 displays an upgrade setting screen for the multifunction device 1 if the multifunction device 1 may be upgraded. FIG. 13 illustrates a display example of a firmware update setting detail screen displayed when the device ID 64 corresponding to the multifunction device mfp01 is selected in FIG. 12. The “upgrade setting screen” described above is the “firmware update setting detail screen”.

As described by using FIG. 10, the upgrade setting screen is displayed only for a multifunction device 1 having a function which has been used and for which update information is present. When the device ID 64 corresponding to a multifunction device 1 other than this is selected, information about the multifunction device 1, not for setting an upgrade, is presented to the manager. For example, the function-used information in FIG. 7 is presented to the manager. Alternatively, there may be the case in which the multifunction device 1, which is not used in the period in which the function-used information is to be generated, may be used before that. In consideration of this case, the use history log may be referred to, and utilization information before that may be presented.

In response to the manager's selection of a device ID 64, the manager cooperation processor 431 displays, on the screen of the manager terminal 2, a firmware update setting detail screen for setting an upgrade of the multifunction device 1, whose device ID has been selected, in this example, the multifunction device mfp01. FIG. 13 illustrates an information display area 65, in which the multifunction device 1 which is to be processed, the model of the multifunction device 1, information about the firmware, and the like are displayed, and a setting area 66 for setting an upgrade. The setting area 66 contains a selection area, in which functions to be upgraded are selected, and an area for setting a reservation of the upgrade. In the display example in FIG. 13, the finisher function, which has not been used in the multifunction device mfp01, is not an upgrade target. In contrast, the functions, which have been used and which are upgrade targets, are displayed in association with check boxes 67. The manager checks the check boxes 67 corresponding to the functions which are to be upgraded. Each function is displayed in association with information which is set in the function-used information, specifically, the number of users of the function. Thus, the manager may use the function use information as a determination index used to determine whether the check boxes 67 are to be checked.

The manager selects radio buttons to specify whether the upgrade is to be performed. When the upgrade is to be performed, the manager subsequently specifies a date and time at which the upgrade is to be performed in the multifunction device 1. The manager selects a reservation button 68 to reserve execution of the upgrade. The manager cooperation processor 431 instructs a manager to perform operations as described above. Thus, the manager cooperation processor 431 sets an upgrade of software for each multifunction device 1 (step 126).

When upgrades are to be reserved similarly for the other multifunction devices 1, or when information about multifunction devices 1, which are not upgrade targets, is to be checked, a return button 69 is selected to display the firmware update setting list screen in FIG. 12 again for selection of another device ID 64.

As described above, the manager cooperation processor 431 uses the screens in FIGS. 11 to 13 to control an update of the software for each multifunction device 1 in response to an instruction from a manager through the screens. As described above, even if functions have been used and update information for the functions is present, the manager cooperation processor 431 selects only functions, for which the check boxes 67 are checked by the manager for selection, as update targets.

The process is repeatedly performed for each multifunction device 1 (step 124). In this example, as illustrated in FIGS. 11 to 13, an instruction for a single multifunction device 1 is received. However, in FIG. 12, in consideration of convenience of a manager and efficiency of the process, the multifunction devices 1, which are managed by the manager, are collectively displayed in the update information display area 63. Therefore, the multifunction devices 1 displayed in the update information display area 63 are handled as multifunction devices 1, which have been processed, in the process described below.

When the manager selects the reservation button 68 to transmit an instruction for a reservation, the reservation processor 432 generates reservation information in accordance with the information which is set from the firmware update setting detail screen, and registers the reservation information in the reservation-information storage unit 56 (step 127).

The processes described above are performed for each multifunction device 1. If all the multifunction devices 1 have been processed (Y in step 128), the update management server 4 ends the upgrade setup process.

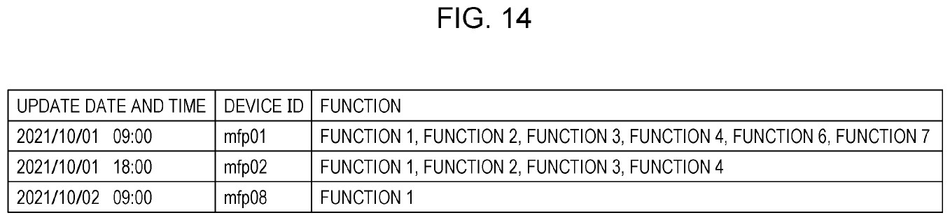

FIG. 14 is a diagram illustrating an exemplary data configuration of reservation information stored in the reservation-information storage unit 56, according to the present exemplary embodiment. The reservation information is generated in accordance with setting of reservations performed by the managers. The reservation information is set by associating the update date and time, the device ID, and the function with each other. As the update date and time, a date and time, which was set by a manager and at which execution of an upgrade starts to update the software, is set. As the device ID, the device ID of a multifunction device 1, which is an upgrade target, is set. As the function, the functions, which are determined to be upgrade targets by the manager checking their check boxes 67 on the firmware update setting detail screen, are set.

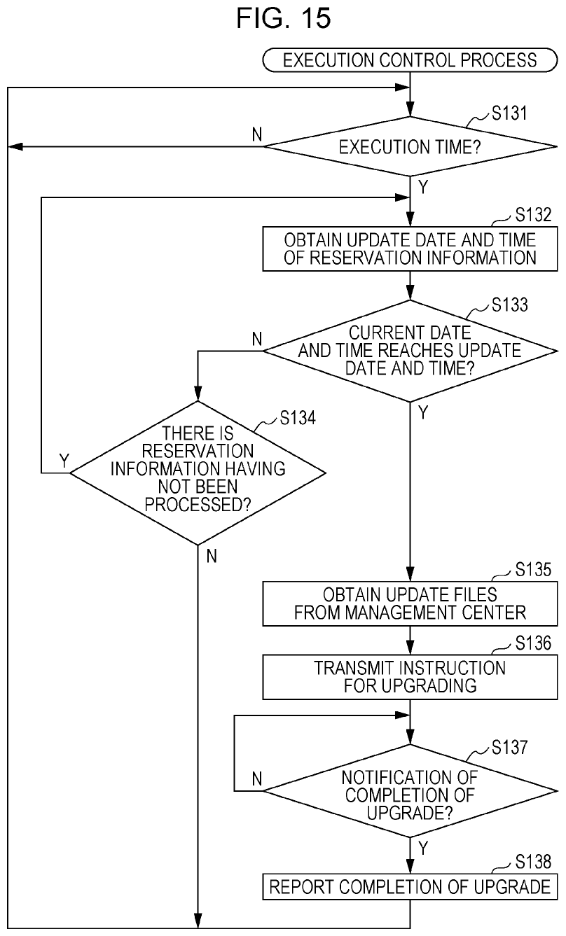

An upgrade execution control process performed by the execution controller 44 of the update management server 4 will be described below by using the flowchart in FIG. 15.

The execution controller 44, which operates all the time, performs the process, which is described below, at a predetermined execution time, for example, every hour. The execution controller 44 waits until the predetermined execution time comes (N in step 131). If the execution time comes (Y in step 131), the execution controller 44 reads one piece of reservation information which is registered in the reservation-information storage unit 56 and which has not been processed. The execution controller 44 obtains the update date and time of the piece of reservation information (step 132). Subsequently, the execution controller 44 compares the obtained update date and time with the current date and time. If the current date and time does not reach the update date and time (N in step 133), the execution controller 44 extracts one piece of reservation information that has not been processed (Y in step 134, step 132). If there are no pieces of reservation information that have not been processed (N in step 134), the execution controller 44 waits until the next execution time comes (step 131).

If the current date and time reaches the update date and time (Y in step 133), the execution controller 44 transmits, to the management center 3, a request to transmit update files corresponding to the functions included in the piece of reservation information.

In response to the transmission request, the update file providing unit 32 of the management center 3 transmits update files for the functions to the update management server 4 from which the request has been transmitted.

When the execution controller 44 obtains update files corresponding to the functions, which are upgrade targets, as described above (step 135), the execution controller 44 transmits the obtained update files to the multifunction device 1 having a device ID which is set in the piece of reservation information. Thus, the execution controller 44 transmits an instruction to upgrade the functions, that is, upgrade the software including the functions (step 136). After that, the execution controller 44 waits until a notification of completion of the upgrade is received from the multifunction device 1 (N in step 137).

The upgrade processor 13 of the multifunction device 1 executes the update files according to the instruction from the update management server 4. Thus, the upgrade processor 13 upgrades the functions corresponding to the update files. If multiple functions are to be upgraded, multiple functions included in a piece of software are updated sequentially. When the upgrade of the software is completed, the upgrade processor 13 notifies the update management server 4 that the upgrade is completed.

If a notification of completion of the upgrade is received from the multifunction device 1 (Y in step 137), the execution controller 44 reports this to the manager by mail (step 138). After that, the execution controller 44 waits until the next execution time comes (step 131). The pieces of reservation information, which have been processed, are not necessary, and may be deleted at an appropriate time.

In the present exemplary embodiment, the software installed in the multifunction devices 1 is upgraded as described above. As described above, only functions that have been used are upgraded. Functions that are not used are not upgraded even when update files, which are to be executed, for the functions are present. Thus, the time necessary to update the software may be reduced.

There is software for which an update file is prepared for the entire software. That is, update files for all the functions that are to be updated are packaged in one file. When this case is applied to the example described above, an update file is not prepared for each function, such as the finisher function, the scan function, and the automatic feed function. An update file including update files for the functions, that is, the finisher function, the scan function, and the automatic feed function, is prepared for each model. In this case, a multifunction device 1 receives one update package file from the update management server 4. That is, the multifunction device 1 also receives update files corresponding to functions that are not update targets (in the example described above, the “finisher function”). In this case, the upgrade processor 13 may upgrade only the functions, which are selected by the update management server 4, among the functions included in the update file.

In the description above, under management of the managers, functions selected by the managers are upgraded at the specified reservation dates and times. Alternatively, when functions, which are upgrade targets, are specified, the update function specifying unit 43 may instruct the execution controller 44 to upgrade the functions, without asking the managers, at a predetermined time, for example, at a time at which the functions may be specified, or at a predetermined time, for example, after end of business hour. This enables automatization of upgrades.

In the present exemplary embodiment, the example in which the multifunction devices 1, which are used by multiple users, are used as devices in which software to be updated is installed is described. Functions, which have not been used, are specified from the multiple functions included in the software. Alternatively, the present exemplary embodiment may be applied to a device, such as a smartphone or a tablet terminal, which is used by a single user. For example, multiple applications are downloaded and installed in a smartphone. Some of the downloaded applications may not be used at all over time. Thus, similar selection of applications, which have not been used, enables such applications to be excluded from upgrade targets.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
accumulate use-record information in a storage unit, the use-record information including utilization of a plurality of functions in a device in a predetermined period, the device having software including the plurality of functions; and,
when the software needs to be updated, exert control to cause a function to be selected, for update, among the plurality of functions included in the software, the selected function having been used in the device, the selection being performed by referring to the use-record information.

2. The information processing apparatus according to claim 1,
wherein the processor is configured to:
obtain update information of the software from a management center of the software; and,
in accordance with content of the obtained update information of the software, notify a manager that the software needs to be updated, the manager managing the device.

3. The information processing apparatus according to claim 2,
wherein the processor is configured to:
in response to an instruction from the manager, control an update of the function having been used in the device.

4. The information processing apparatus according to claim 3,
wherein the processor is configured to:
instruct the device to update, at an update date and time, the function having been used in the device, the update date and time being specified by the manager.

5. The information processing apparatus according to claim 1,
wherein the processor is configured to:
refer to the use-record information to specify the function having been used in the device.

6. The information processing apparatus according to claim 5,
wherein the use-record information includes a function having been used in the predetermined period and a count of users who have used the function, and
wherein the function having been used in the device is a function having been used by a predetermined number or more of users in the predetermined period.

7. The information processing apparatus according to claim 1,
wherein the processor is configured to:
present the use-record information to a manager of the device, the use-record information corresponding to at least one function having been used in the device; and
select, as an update target, a function selected by the manager among the at least one function having been used in the device, the manager referring to the use-record information.

8. The information processing apparatus according to claim 1,
wherein the software is firmware.

9. A non-transitory computer readable medium storing a program causing a computer to execute a process comprising:
accumulating use-record information in a storage unit, the use-record information including utilization of a plurality of functions in a device in a predetermined period, the device having software including the plurality of functions; and,
when the software needs to be updated, exerting control to cause a function to be selected, for update, among the plurality of functions included in the software, the selected function having been used in the device, the selection being performed by referring to the use-record information.

10. An information processing method comprising:
accumulating use-record information in a storage unit, the use-record information including utilization of a plurality of functions in a device in a predetermined period, the device having software including the plurality of functions; and,
when the software needs to be updated, exerting control to cause a function to be selected, for update, among the plurality of functions included in the software, the selected function having been used in the device, the selection being performed by referring to the use-record information.
